(19) United States
(12) Patent Application Publication
(10) Pub. No.: US 2009/0099871 A1
(43) Pub. Date: Apr. 16, 2009

(54) Workflow Oriented Multiscreen Healthcare Information Management System

(76) Inventor: Gopal Gadodia, Melbourne, FL (US)

Correspondence Address: MCDERMOTT WILL & EMERY LLP, 600 13TH STREET, N.W., WASHINGTON, DC, 20005-3096, US

(21) Appl. No.: 11/990,181

(22) PCT Filed: Aug. 9, 2006
(86) PCT No.: PCT/US2006/031040

§ 371 Date: Feb. 8, 2008

Related U.S. Application Data
(60) Provisional application No. 60/706,411, filed on Aug. 9, 2005.

(51) Int. Cl. G06Q 10/00; G06Q 50/00; G06F 19/00

(52) U.S. Cl. 705/3; 705/2

(57) ABSTRACT

The present invention discloses a workflow oriented multi-screen healthcare information management system. The present invention allows the user to simultaneously access, display, and manipulate various healthcare information that are logically related on multiple screens without having to jump around or entering and exiting various screens. In particular, the present invention provides a first screen for managing information for a first point in the healthcare workflow and a second screen for managing information for a second point in the healthcare workflow, where the first screen and the second screen has a logical relation in the healthcare workflow. Various tasks in the healthcare workflow can be streamlined utilizing the system of the present invention. Specifically, the first and second screens can conveniently display complete patient history. The physician can write orders while viewing labs and medications. An X-ray report and problem list will be visible at the same time while the physician is writing SOAP notes. Writing discharge orders is simplified since all prescribed medications can be automatically printed. In addition, physician's orders are transmitted and processed automatically. As the result, physicians will benefit from improved efficiency, less time spent on charting, and more time spent with the patients. Errors will be reduced significantly throughout the entire healthcare process or workflow.

### CROSS-REFERENCES AND RELATED APPLICATIONS

This application claims priority to U.S. Provisional Application No. 60/706,411, filed Aug. 9, 2005, and entitled “MEDICAL RECORDS SYSTEM INCLUDING MULTIPLE DISPLAYS”, which is herein incorporated by reference in its entirety for all purposes.

### BACKGROUND OF THE INVENTION

1. Field of the Invention

The present invention relates to healthcare information management systems. Specifically, the present invention relates to a workflow oriented multi-screen healthcare information management system.

2. Description of the Related Art

Modern healthcare practices rely heavily on various information management systems to store, retrieve, and display healthcare-related information. For example, hospitals employ various medical record systems from the point of patient admission to testing, diagnosis, treatment, and discharge of the patient.

FIG. 1 illustrates a hospital workflow and various healthcare information management systems employed at various points in the workflow. As shown in FIG. 1, a hospital workflow 100 may start with Patient Admission 110 and Patient Data Entry 120 upon admission. The step of Patient Data Entry 120 requires a data or information management system, e.g., a Hospital Medical Record System 122, to enter and store various healthcare-related information for the patient, such as the patient demographics, symptoms, patient complaints, and insurance or billing information.

After the patient has been admitted, an initial evaluation may be made by the attending physician who may order various lab tests or radiological tests. In addition, the patient may be referred to specialists for further consultation. The results of the lab tests are typically entered and stored on a Lab Information System 130. Similarly, the radiological testing results may be entered and stored on a Radiology Information System 140.

When making a definitive diagnosis, a physician needs to have access to the information stored on the Hospital Medical Record System 122, the Lab Information System 130, and the Radiology Information System 140, as well as access to the reports and notes from the consulting specialists. In the existing systems, these information systems are typically disparate systems with separate display monitors or display stations. Even when the various information are displayed through one display station, the screens or displays from different information systems remain separate from each other and switching from one screen to another requires exiting from a screen or exiting from the information system being switched out. In addition, the various information systems have no awareness of other systems in the healthcare workflow because the information systems are separate from each other, as discussed above. Because the information displays are organized on a single-screen basis without regard to other systems or hospital workflow, the user sometimes must go through a number of screens to locate the information needed. As the result, accessing items of information that must be considered next to each other can frequently require jumping around a long series of screens.

The same problem persists throughout the remainder of the hospital workflow such as Physician's Orders 150, Discharge 160, and Post-discharge Orders 170, interacting with Pharmacy System 180 and Hospital Medical Record System 122. The result is a patchwork of information systems that provide disparate information displays without regard to other information systems or hospital workflow. Consequently, accessing multiple items of information simultaneously as required by the healthcare practice is laborious and time-consuming. In addition, the integration of various healthcare information must be done manually or even “on the fly” by the physicians or other healthcare workers during the patient care and treatment process.

It can be seen, then, there is a need in the field of healthcare information management systems for a consolidated healthcare information system that organizes displays or screens according to the logic of the healthcare process or workflow.

### SUMMARY OF THE INVENTION

Accordingly, the present invention addresses the foregoing need by providing a workflow oriented multi-screen healthcare information management system.

In one aspect of the present invention, the present invention is a workflow oriented multi-screen healthcare information management system including a first screen for managing information in a healthcare workflow with two or more screen areas for providing healthcare information display and manipulation functions for a first point in the healthcare workflow, a second screen for managing information in the healthcare workflow with two or more screen areas for providing healthcare information display and manipulation functions for a second point in the healthcare workflow, an interface to one or more healthcare information systems, and an information integration module to integrate information on the one or more healthcare information systems with the first screen and the second screen such that the information on the one or more healthcare information systems are managed from the first screen and the second screen, where the first screen and the second screen has a logical relation in the healthcare workflow, and a user can switch between the first screen and the second screen without exiting either screen.

According to one aspect of the invention, the present invention is a method for workflow oriented multi-screen healthcare information management including displaying a first screen for managing information for a first point in a healthcare workflow, displaying within the first screen two or more screen areas for providing healthcare information display and manipulation functions, providing within the two or more screen areas of the first screen healthcare information display and manipulation functions for the first point in a healthcare workflow, displaying a second screen for managing information for a second point in a healthcare workflow, displaying within the second screen two or more screen areas for providing healthcare information display and manipulation functions, providing within the two or more screen areas of the second screen healthcare information display and manipulation functions for the second point in a healthcare workflow, providing an interface to one or more healthcare information systems, and integrating information on the one or more healthcare information systems with the first screen and the second screen for managing information in the healthcare workflow such that the information on the one or more healthcare information systems are managed from the first screen and the second screen, where the first screen and the second screen has a logical relation in the healthcare workflow, and a user can switch between the first screen and the second screen without exiting either screen.

According to another aspect of the invention, the present invention is a system for workflow oriented multi-screen healthcare information management including means for displaying a first screen for managing information for a first point in a healthcare workflow, means for displaying within the first screen two or more screen areas for providing healthcare information display and manipulation functions, means for providing within the two or more screen areas of the first screen healthcare information display and manipulation functions for the first point in a healthcare workflow, means for displaying a second screen for managing information for a second point in a healthcare workflow, means for displaying within the second screen two or more screen areas for providing healthcare information display and manipulation functions, means for providing within the two or more screen areas of the second screen healthcare information display and manipulation functions for the second point in a healthcare workflow, means for providing an interface to one or more healthcare information systems, and means for integrating information on the one or more healthcare information systems with the first screen and the second screen for managing information in the healthcare workflow such that the information on the one or more healthcare information systems are managed from the first screen and the second screen, where the first screen and the second screen has a logical relation in the healthcare workflow, and a user can switch between the first screen and the second screen without exiting either screen.

According to yet another aspect of the invention, the present invention is computer-executable process steps for workflow oriented multi-screen healthcare information management including a step for displaying a first screen for managing information for a first point in a healthcare workflow, a step for displaying within the first screen two or more screen areas for providing healthcare information display and manipulation functions, a step for providing within the two or more screen areas of the first screen healthcare information display and manipulation functions for the first point in a healthcare workflow, a step for displaying a second screen for managing information for a second point in a healthcare workflow, a step for displaying within the second screen two or more screen areas for providing healthcare information display and manipulation functions, a step for providing within the two or more screen areas of the second screen healthcare information display and manipulation functions for the second point in a healthcare workflow, a step for providing an interface to one or more healthcare information systems, and a step for integrating information on the one or more healthcare information systems with the first screen and the second screen for managing information in the healthcare workflow such that the information on the one or more healthcare information systems are managed from the first screen and the second screen, where the first screen and the second screen has a logical relation in the healthcare workflow, and a user can switch between the first screen and the second screen without exiting either screen.

Other and further objects and advantages of the present invention will be further understood and appreciated by those skilled in the art by reference to the following specification, claims, and drawings.

### BRIEF DESCRIPTION OF THE DRAWINGS

Referring now to the drawings in which like reference numbers represent corresponding parts throughout:

FIG. 1 illustrates a hospital workflow and various healthcare information management systems employed at various points in the workflow;

FIG. 2 illustrates an embodiment a workflow oriented multi-screen healthcare information management system according to the present invention;

FIG. 3 illustrates display of two simultaneous screens according to the present invention;

FIG. 4 illustrates another embodiment of display of two simultaneous screens according to the present invention;

FIG. 5 illustrates yet another embodiment of display of two simultaneous screens according to the present invention;

FIG. 6 illustrates yet another embodiment of display of two simultaneous screens according to the present invention;

FIG. 7 illustrates a patient demographics page according to the present invention;

FIG. 8 illustrates a history notes and progress notes page according to the present invention;

FIG. 9 illustrates a history/physicians page according to the present invention;

FIG. 10 illustrates an X-rays/EKG notes page according to the present invention;

FIG. 11 illustrates an X-rays/EKG image page according to the present invention;

FIG. 12 illustrates a consultation page according to the present invention;

FIG. 13 illustrates a medications/physician's orders page according to the present invention;

FIG. 14 illustrates a lab page according to the present invention;

FIG. 15 illustrates a surgery procedure page according to the present invention;

FIG. 16 illustrates a nurses notes page according to the present invention;

FIG. 17 illustrates an advanced directives page according to the present invention;

FIGS. 18, 19, 20, 21, 22, and 23 illustrate physician's orders pages according to the present invention; and

FIG. 24 illustrates a verify all orders page according to the present invention.

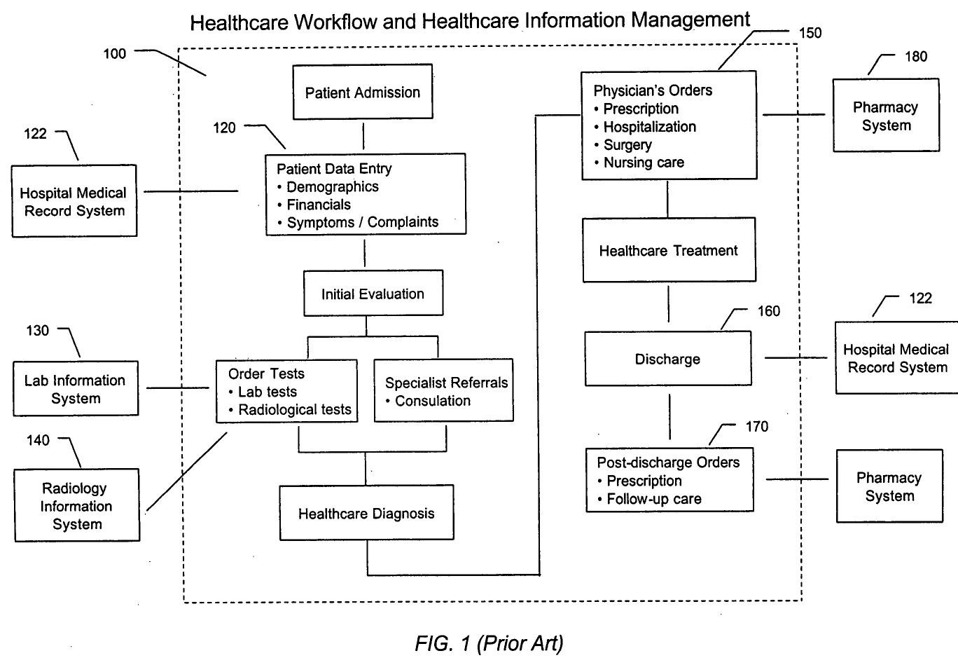

### DETAILED DESCRIPTION OF THE INVENTION

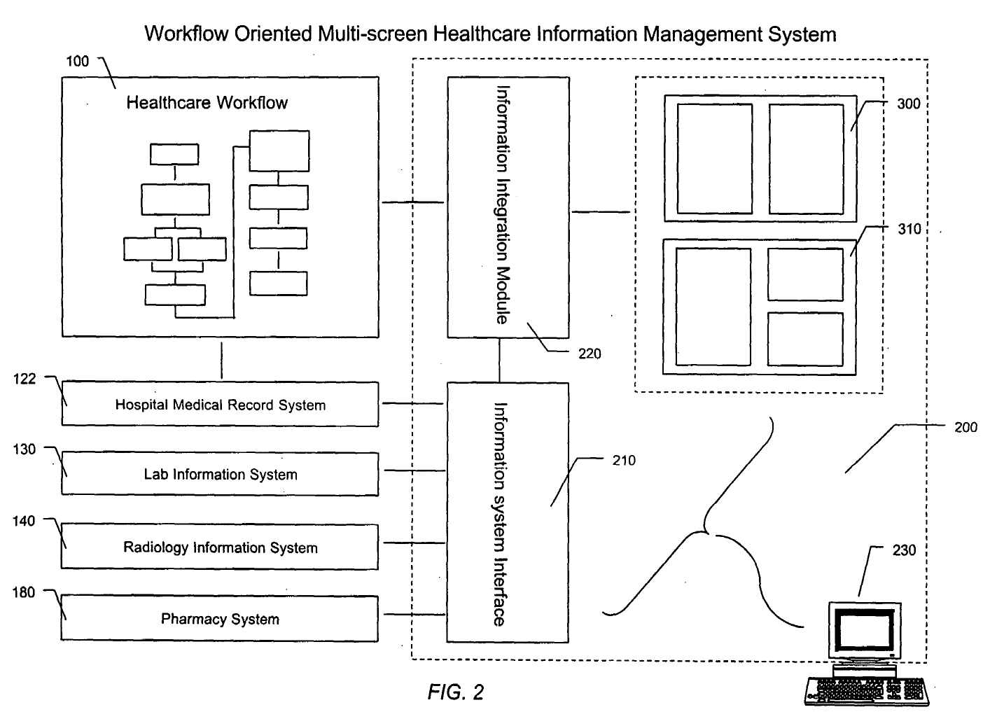

FIG. 2 illustrates an embodiment of a workflow oriented multi-screen healthcare information management system according to the present invention. As shown in FIG. 2, a workflow oriented multi-screen healthcare information management system according to the present invention consolidates healthcare information from various healthcare information systems in a healthcare workflow 100, and organizes information displays or screens according to the logic of the healthcare process or workflow 100.

According to one aspect of the present invention, the present invention is a workflow oriented multi-screen healthcare information management system including a first screen for managing information in a healthcare workflow with two or more screen areas for providing healthcare information display and manipulation functions for a first point in the healthcare workflow, a second screen for managing information in the healthcare workflow with two or more screen areas for providing healthcare information display and manipulation functions for a second point in the healthcare workflow, an interface to one or more healthcare information systems, and an information integration module to integrate information on the one or more healthcare information systems with the first screen and the second screen such that the information on the one or more healthcare information systems are managed from the first screen and the second screen, where the first screen and the second screen has a logical relation in the healthcare workflow, and a user can switch between the first screen and the second screen without exiting either screen.

As shown in FIG. 2, a healthcare workflow 100 may interact with various healthcare information systems throughout the healthcare workflow, such as the Hospital Medical Record System 122, the Lab Information System 130, the Radiology Information System 140, and the Pharmacy System 180. The workflow oriented healthcare information management system 200 according to the present invention interfaces with these various healthcare information systems utilizing an Information System Interface 210. The healthcare information from the various healthcare information systems are retrieved, collected, and transmitted to be stored through the Information System Interface 210. The Information System Interface 210 can be implemented as a software or computer program module on a general purpose computer, or, alternatively, as dedicated hardware module with firmware without departing from the scope of the present invention. The Information System Interface 210 can communicate with the various healthcare information systems over any communication or network link well known to those skilled in the art of computer communication, including, but not limited to, LAN connections such as the Ethernet, Internet connections over various WAN/LAN hardware and TCP/IP protocol with security measures and secure communication protocols if necessary, and various serial and/or parallel connections such as an LIS connection over a serial link, without departing from the scope of the present invention.

The healthcare information from the various healthcare information systems retrieved and collected through the Information System Interface 210 are organized utilizing an Information Integration Module 220. According to the present invention, the various healthcare information are organized on the basis of various logical relations or logical connections in the healthcare workflow so that the appropriate healthcare information can be accessed and displayed as organized according to the logical relation between the various items of healthcare information. For example, healthcare diagnosis is directly related to lab test information and/or radiological test information as well as the results of specialist consultation in a healthcare process or workflow. Thus, a physician may desire access and display of these items of information simultaneously without having to search for them and jump around various screens of the information system display. Accordingly, the system of the present invention allows access and displays of these data or information items that are logically related in a healthcare process through two split screens 300 and 310, as shown in FIG. 2.

Organization of healthcare data items can be implemented in the Information Integration Module 220 by any data or information organization methods or technologies well known to those skilled in the art of database or information organization, such as data structures in computer code, various databases including relational and object-oriented databases, and customizable templates, without departing from the scope of the present invention.

Organization of displays or screens can be implemented utilizing any method or technology well known to those skilled in the art of computer graphics display or graphical user interface (GUI) design, including, but not limited to, various windows-based GUI design such as Microsoft Windows, X-Windows/Motif, and OpenGL, as well as object-oriented GUI design and component-based GUI design, without departing from the scope of the present invention.

Most common sets of data grouping and coupled screen organization can be provided as default selection menus. In addition, the screen and data organization can be customized by users graphical editing tools and customizable templates such as the XML templates, without departing from the scope of the present invention.

The logical relations in the healthcare workflow can be logical relationship or connection in the healthcare or patient care process, business-related connections or relationships, connections or relationships in the operational or administrative aspects of an healthcare organization, and finance-related relationships such as billing, accounting, and insurance, without departing from the scope of the present invention.

The workflow oriented healthcare information management system 200 according to the present invention can be an integration system that interfaces with and integrates various existing healthcare information system, or, alternatively, a standalone system that provides all of the functions for the healthcare information management, without departing from the scope of the present invention.

The workflow oriented healthcare information management system 200 according to the present invention can be implemented in a System Computer 230, which can be a desktop computer, a workstation, a server computer, a laptop computer, or a thin-client workstation, without departing from the scope of the present invention. Additionally, the screens 300 and 310 can be displayed on a separate hardware for the purpose of displaying the screens, which can be a computer, a terminal, a thin-client, or a display station, without departing from the scope of the present invention.

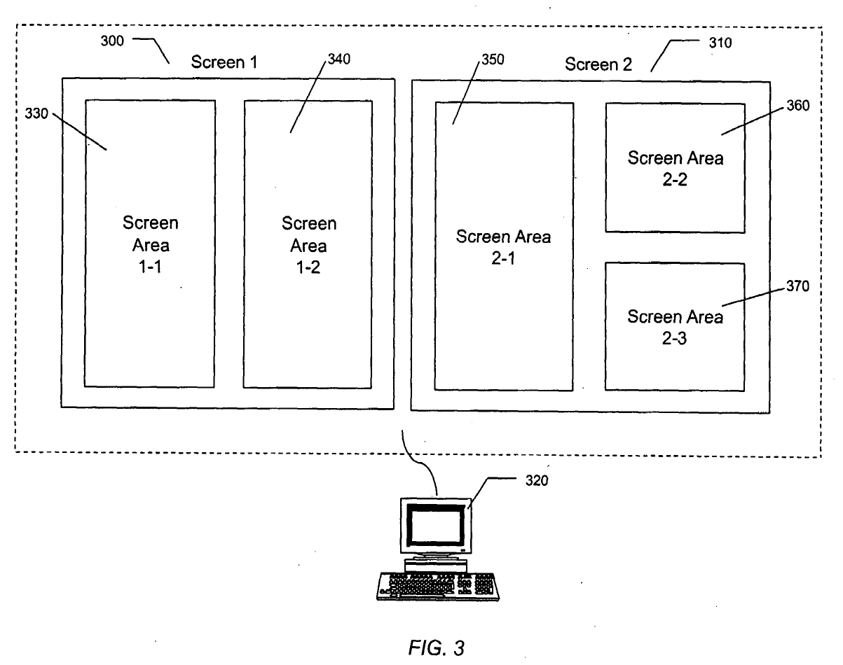

FIG. 3 illustrates display of two simultaneous screens according to the present invention. As shown in FIG. 3, two screens—a First Screen 300 and a Second Screen 310—are displayed simultaneously on a Display Computer 320. As discussed above, various logically related healthcare information can be accessed and displayed simultaneously on the First Screen 300 and the Second Screen 310. Specifically, the First Screen 300 and the Second Screen 310 can each comprises two or more screen areas 330, 340, 350, 360, and 370 for providing healthcare information display and manipulation functions where the information items on the screen areas are logically related. Furthermore, the organization of the First Screen 300 and the Second Screen 310 is according to a logical relationship in the healthcare workflow.

In addition, because the First Screen 300 and the Second Screen 310 are displayed under a control of a consolidated system—that is, the workflow oriented healthcare information management system 200 according to the present invention—there is no need to exit the screens in order to switch from one screen to another. Although the embodiment in FIG. 3 shows two split screens, it is contemplated by the present invention that such two-screen implementation can be extended to multiple-screen embodiments comprising more than two screens without departing from the scope of the present invention. Alternatively, the two-screen embodiment of the present invention can be a part of a multiple-screen embodiment comprising more than two screens without departing from the scope of the present invention. Such multiple-screen display technology by itself is well known in the art of digital information display, and can be practiced by a person having ordinary skill in the art.

Consequently, by utilizing the workflow oriented healthcare information management system 200 of the present invention, the user can simultaneously access, display, and manipulate various healthcare information that are logically related on multiple screens without having to jump around or entering and exiting various screens. The manipulation and management of healthcare information according to the present invention can include the functions of retrieving, displaying, modifying, creating, entering, storing, and restoring of information or data.

The hardware for the Display Computer 320 can be any computing hardware capable of graphical display known to those skilled in the art of computing, including, but not limited to, a desktop computer, a workstation, a terminal, a thin-client, or a display station, without departing from the scope of the present invention.

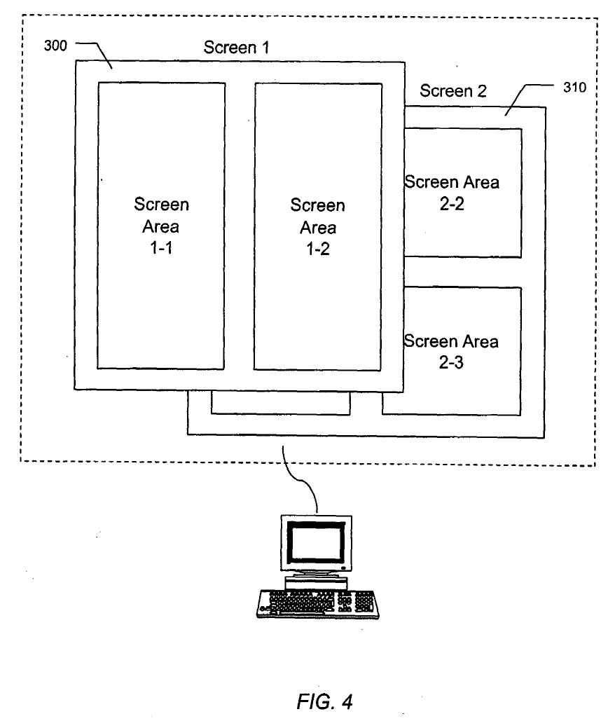

FIG. 4 illustrates another embodiment of display of two simultaneous screens according to the present invention. As shown in FIG. 4, multiple screens of the present invention, and, in particular, the First Screen 300 and the Second Screen 310 can be displayed in an overlapped display without departing from the scope of the present invention. Such overlapped screens can be switched around by clicking on the screen with a mouse or other pointing device or hitting a defined key stroke such as ALT-Tab. By displaying the multiple screens in an overlapped fashion, the user can switch the screens in and out without having to exit any one of the screens. The method of overlapped screens or windows is well known to those skilled in the art of graphical display on computers.

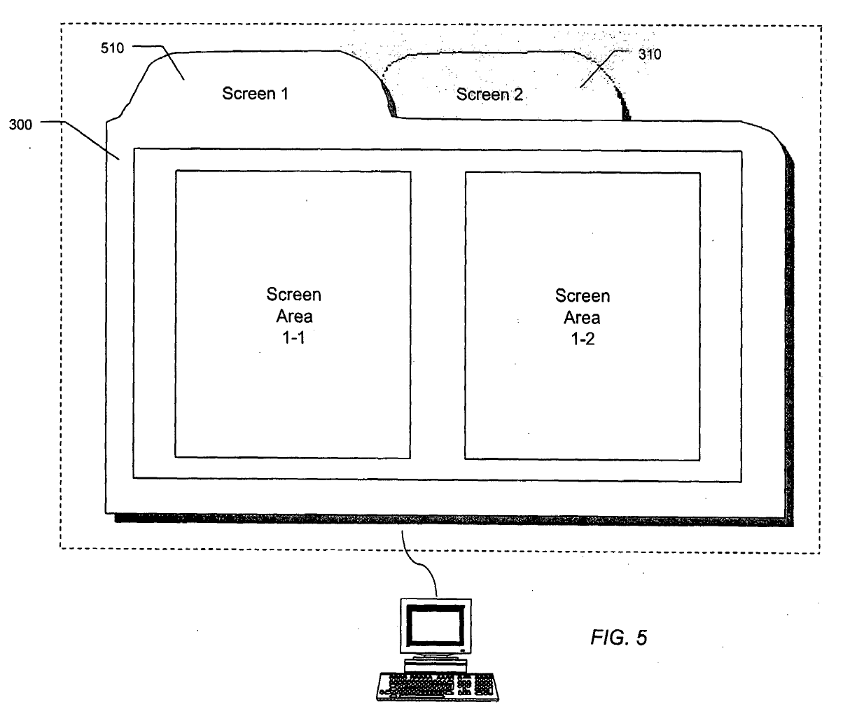

FIG. 5 illustrates yet another embodiment of display of two simultaneous screens according to the present invention. As shown in FIG. 5, multiple screens of the present invention, and, in particular, the First Screen 300 and the Second Screen 310 can be displayed as tabbed screens. Utilizing the tabbed display technology well known in the art, multiple screens can be switched around without exiting any of the screens by clicking on the tab area 510 of the screen with a mouse or other pointing device.

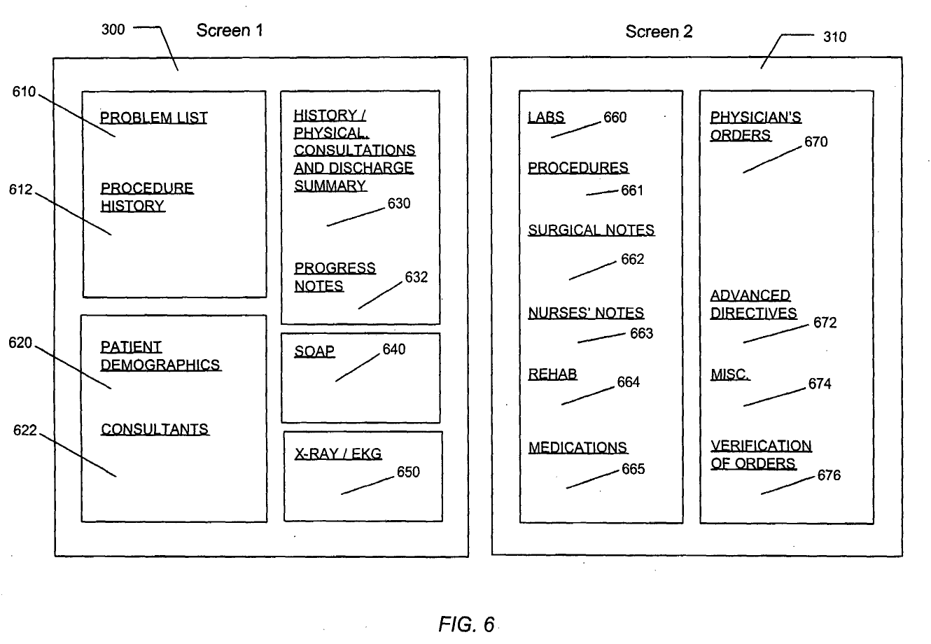

FIG. 6 illustrates yet another embodiment of display of two simultaneous screens according to the present invention. As shown in FIG. 6, the First Screen 300 provides access and display of healthcare information related to patient diagnosis, and the Second Screen 310 provides access and display of healthcare information related to patient treatment and discharge. The two screens shown in FIG. 6 demonstrates display of multiple screens according to an important logical relationship or connection in healthcare process or workflow, namely, the relationship between diagnosis and treatment or discharge. Also, the information items displayed in the screen areas of the screens must necessarily be logically related for the screen display itself to be meaningful.

As shown in FIG. 6, the left side of the First Screen 300 provides access and display of healthcare information in screen areas Problem List 610, Procedure History 612, Patient Demographics 620, and Consultants 622. The Problem List screen area 610 provides access and display of the patient problem information. The date of the patient problem or complaint and accompanying comments can also be displayed in this screen area. The DRG (Diagnosis-Related Group) number is also instituted in this screen area as soon as the diagnosis is made. The Patient Demographics screen area 620 displays patient-related information including, but not limited to, date of birth, social security number, and insurance information. The Consultants screen area 622 displays information-related to specialist consultation including, but not limited to, the names of the consultants, specialty, and the date of consultation.

The right side of the First Screen 300 provides access and display of healthcare information in screen areas History/Physical, Consultations And Discharge Summary 630, Progress Notes 632, SOAP 640, and X-ray/EKG 650. The SOAP screen area 640 provides a screen space to write SOAP (Symptoms, Objective findings, Assessment and Plan) notes by physicians. The SOAP notes can also be written by utilizing templates without departing from the scope of the present invention. The templates can be created by the physician to suit his or her specific needs. In addition, special templates can be created for specific practice areas such as cardiology, nephrology, etc. Furthermore, data entry for the SOAP notes can be voice-driven so that the physician can dictate their notes. Any speech recognition engine known to those skilled in the art of automated speech or voice recognition can be utilized to provide the voice or dictation interface without departing from the scope of the present invention. Additionally, special vocabulary can be set up for specific practice area or particular physician so that the speech recognition performance can be improved. The X-ray/EKG screen area 650 provides direct display of patient X-ray or EKG information and images in digital mode.

The screen areas of the present invention may also provide scrolling functions if necessary so that the information display can be scrolled up and down within the screen area. The screen area can also be implemented as pop-up screens or tabbed screens without departing from the scope of the present invention.

The left side of the Second Screen 310 provides access and display of healthcare information in screen areas Labs 660, Procedures 661, Surgical Notes 662, Nurses' Notes 663, Rehab 664, and Medications 665. Utilizing the Labs screen area 660, Lab related information can be entered and displayed. Procedures screen area 661 provides access and display of procedural notes, and Surgical Notes screen area 662 provides access and display of surgical notes. The Procedures 661, Surgical Notes 662 screen areas can be displayed as pop-up screens when they are clicked on, without departing from the scope of the present invention. The Nurses' Notes screen area 663 access and display of nurses' notes including vital signs. The Rehab screen area 664 provides access and display of multi-disciplinary notes including social worker notes.

The Medications screen area 665 provides access and display of patient medications. Typically, the medication list will include the starting date, dosage, frequency, and route. The Medications screen area 665 also provides auto-dial/auto-print features which can be activated at the time of patient discharge to automatically dial the pharmacy and transmit the medications, or auto-print the prescriptions for the patient. The physician has only to sign each prescription which will include date, medication, dosage, quantity, and instructions.

The right side of Second Screen 310 provides access and display of healthcare information in screen areas Physician's Orders 670, Advanced Directives 672, Miscellaneous 674, and Verification Of Orders 676. The Physician's Orders screen area 670 can be scrolled up and down to allow users to view physician's orders. This screen area can also be driven by menu commands to send orders to nurses, radiology, ultrasound department, pharmacy, or other hospital departments. Each department would receive orders directly with no need for a unit secretary to scan all the orders and transmit them to different departments. The well-known Physician's Desk Reference (PDR) can be made available if the physician wants to look up a particular medicine. The Advanced Directives screen area 672 can include Do Not Resuscitate Order (DNR) status. The Verification Of Orders screen area 676 can include a menu command or button to provide the function of verifying all orders by the physician. All orders must be verified by the physician before they can be transmitted and processed.

In another aspect of the present invention, healthcare orders will be transmitted and processed automatically. For example, prescriptions will be transmitted automatically to the pharmacy upon physician's verification. The pharmacy can then process the prescription automatically. Similarly, lab orders, X-ray orders, EKG orders, etc. can be transmitted and processed automatically.

FIG. 6 also illustrates an example of displaying a complete patient history in two simultaneous screens according to the present invention. Healthcare information display in two simultaneous screens can be configured to display the complete patient history for a patient. Thus, all of the information necessary to diagnose and/or discharge the patient is conveniently available in one place, and physicians or healthcare professionals can access a complete patient history without having jump around the many screens of the healthcare information system or exiting the screens.

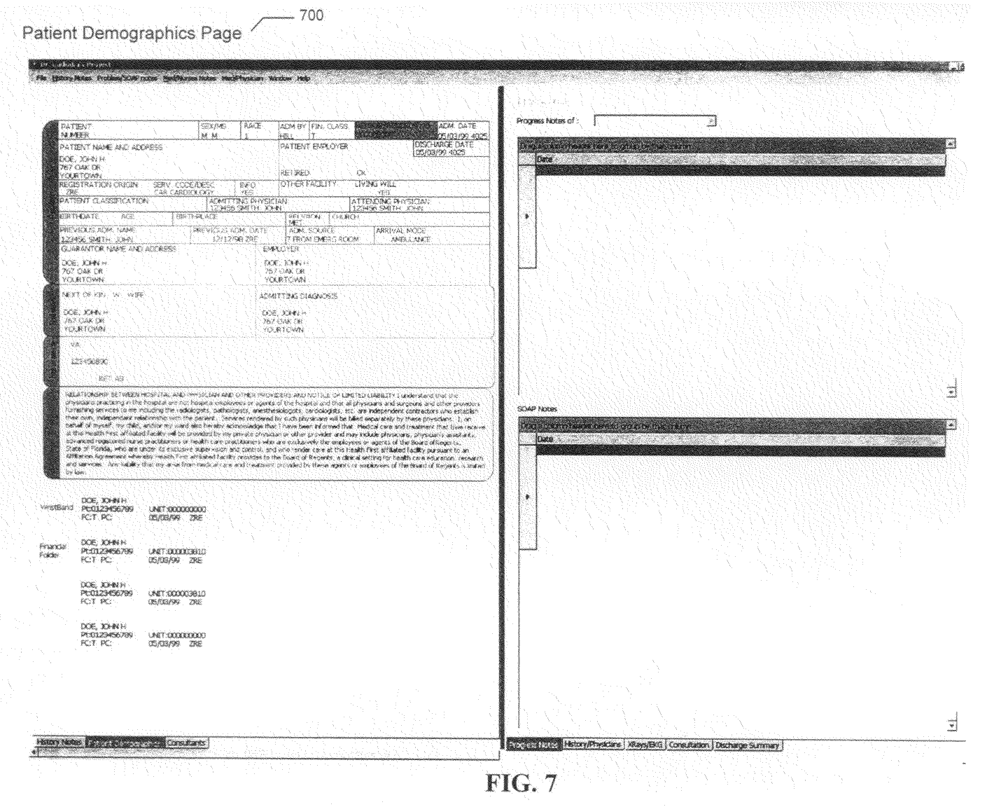

FIG. 7 illustrates a patient demographics page according to the present invention. The Patient Demographic Page 700 can be implemented as a pop-up display screen or window without departing from the scope of the present invention.

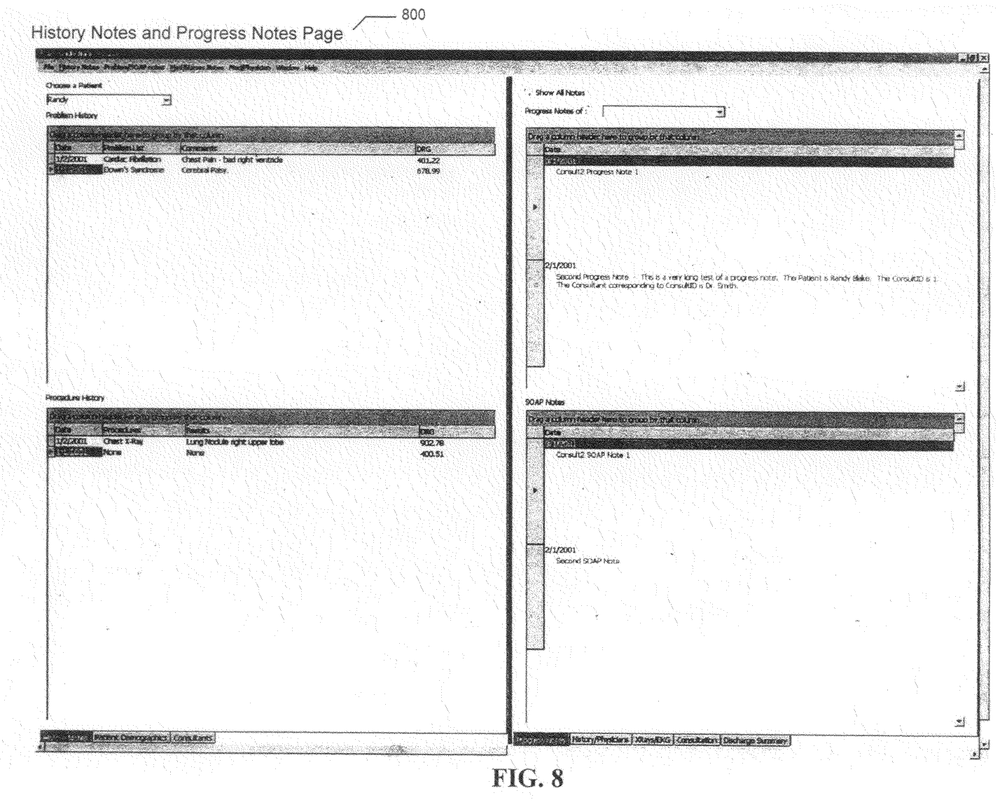

FIG. 8 illustrates a history notes and progress notes page according to the present invention. The History Notes and Progress Notes Page 800 can be implemented as a pop-up display screen or window without departing from the scope of the present invention.

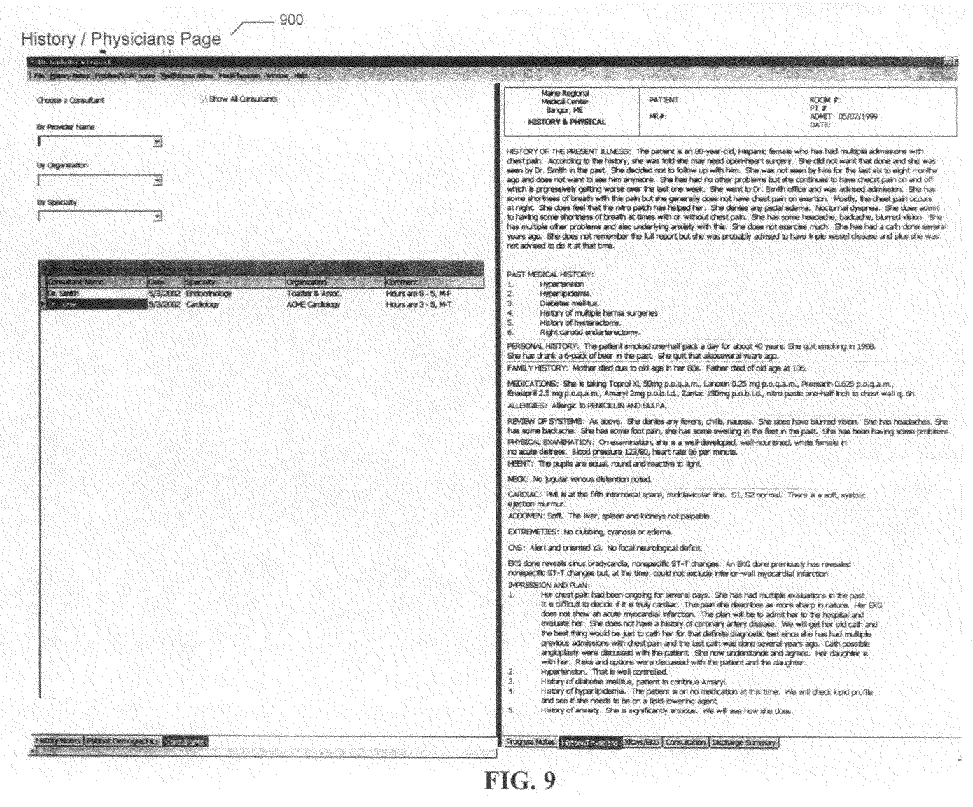

FIG. 9 illustrates a history/physicians page according to the present invention. The History/Physicians Page 900 can be implemented as a pop-up display screen or window without departing from the scope of the present invention.

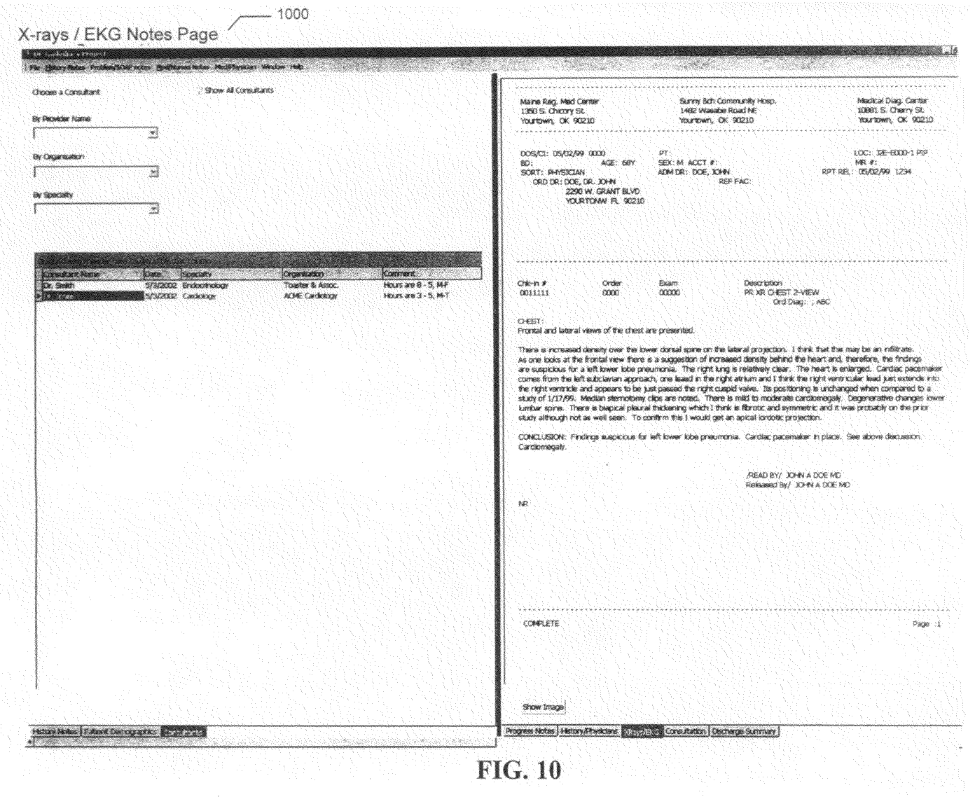

FIG. 10 illustrates an X-rays/EKG notes page according to the present invention. The X-rays/EKG Notes Page 1000 can be implemented as a pop-up display screen or window without departing from the scope of the present invention.

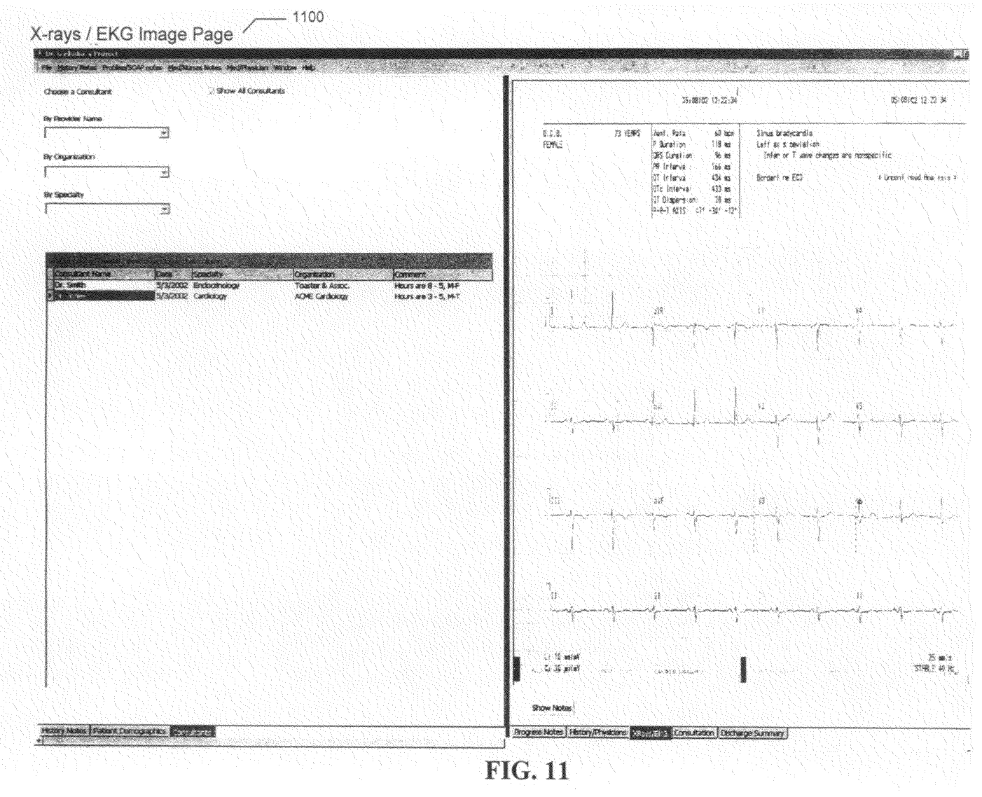

FIG. 11 illustrates an X-rays/EKG image page according to the present invention. The X-rays/EKG Image Page 1100 can be implemented as a pop-up display screen or window without departing from the scope of the present invention.

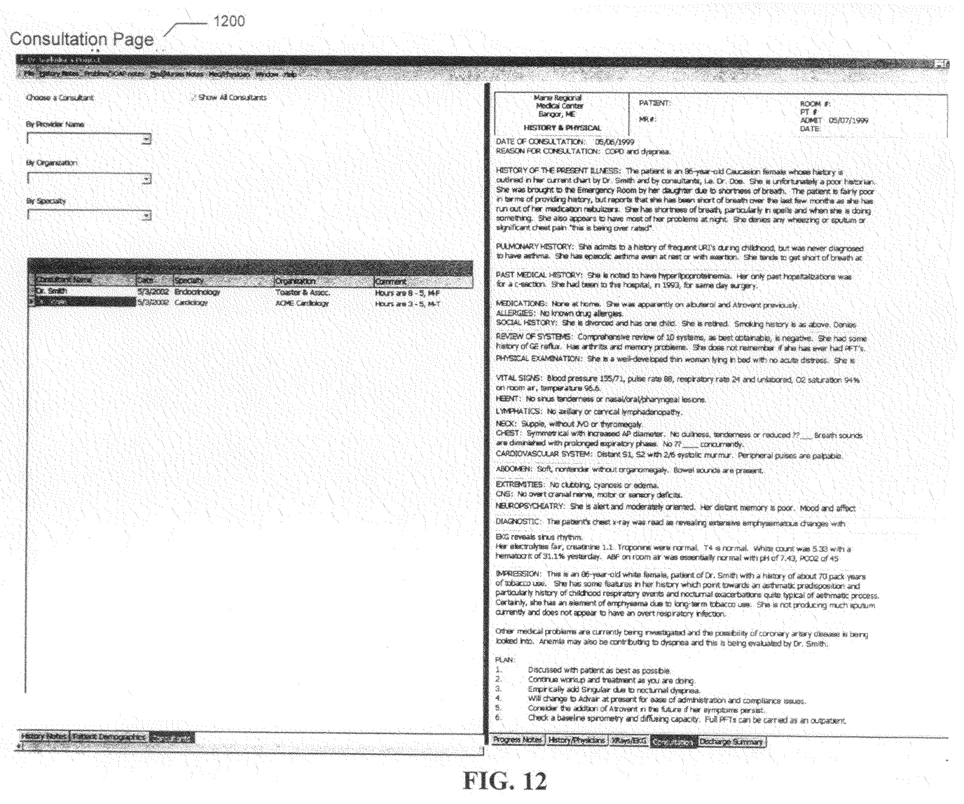

FIG. 12 illustrates a consultation page according to the present invention. The Consultation Page 1200 can be implemented as a pop-up display screen or window without departing from the scope of the present invention.

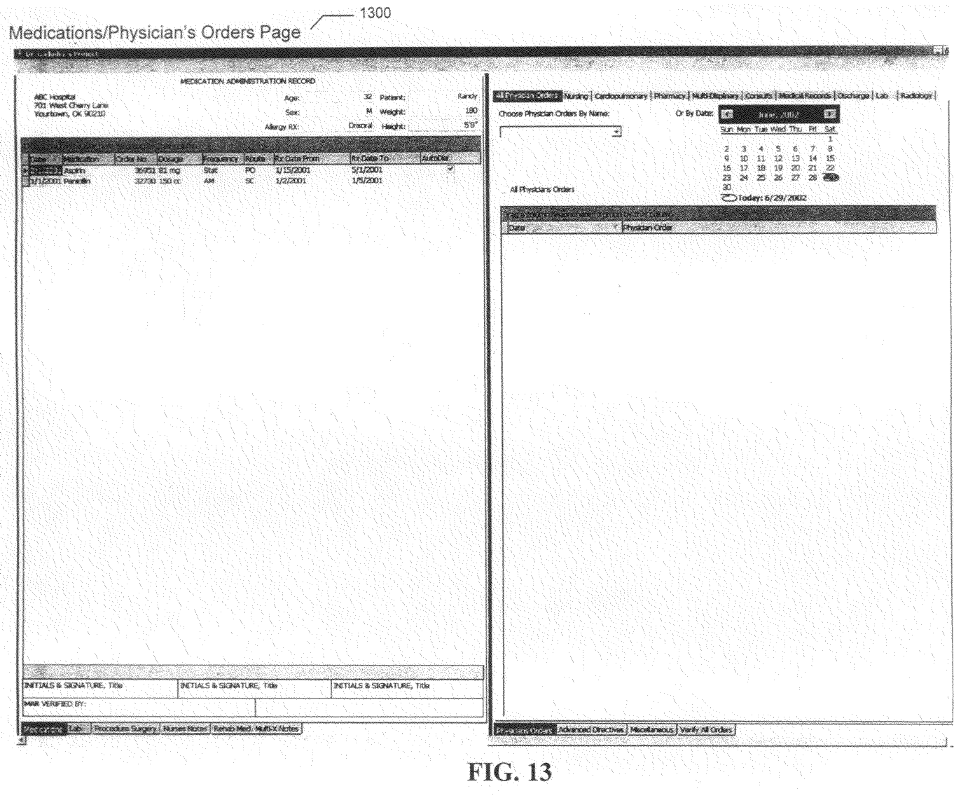

FIG. 13 illustrates a medications/physician's orders page according to the present invention. The Medications/Physician's Orders Page 1300 can be implemented as a pop-up display screen or window without departing from the scope of the present invention.

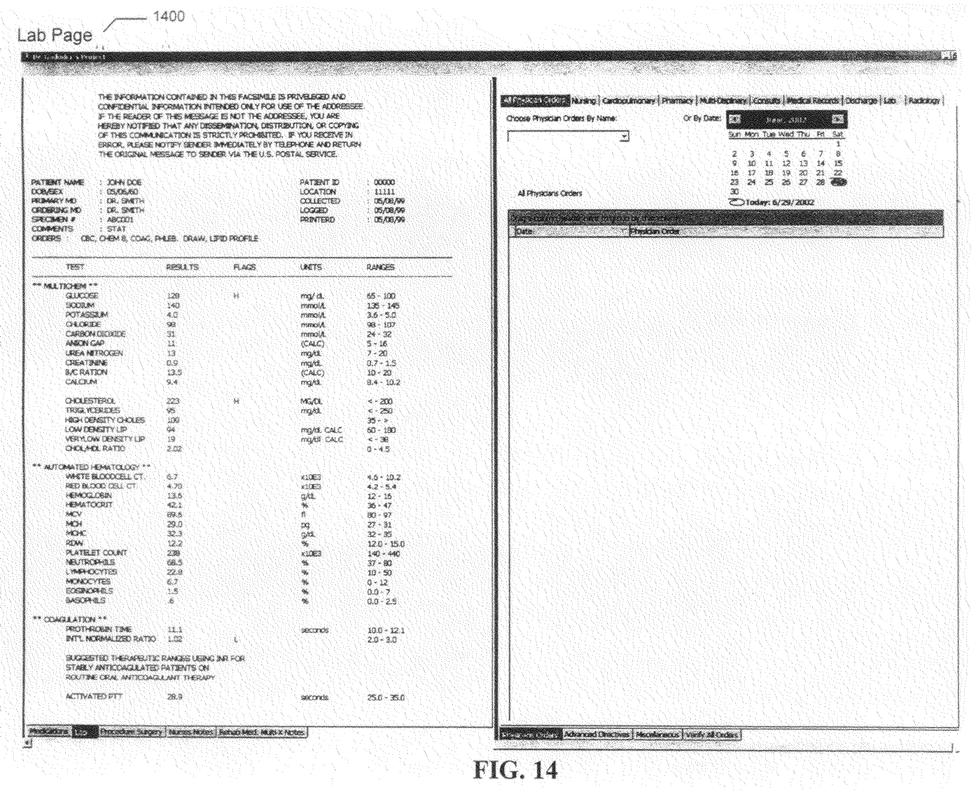

FIG. 14 illustrates a lab page according to the present invention. The Lab Page 1400 can be implemented as a pop-up display screen or window without departing from the scope of the present invention.

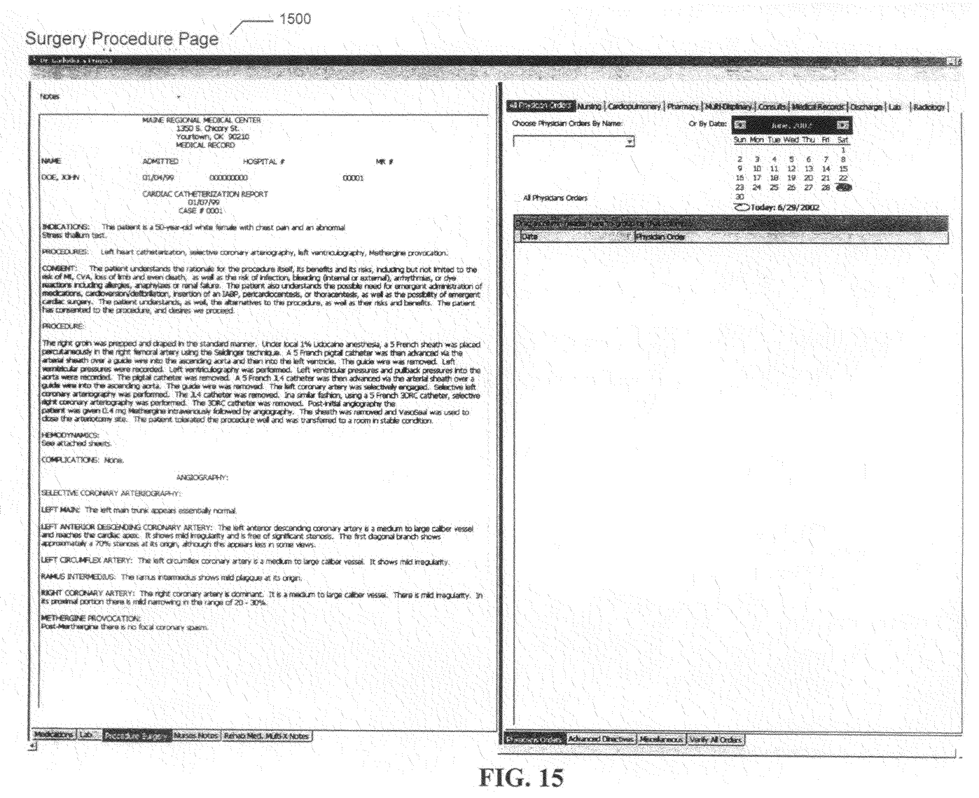

FIG. 15 illustrates a surgery procedure page according to the present invention. The Surgery Procedure Page 1500 can be implemented as a pop-up display screen or window without departing from the scope of the present invention.

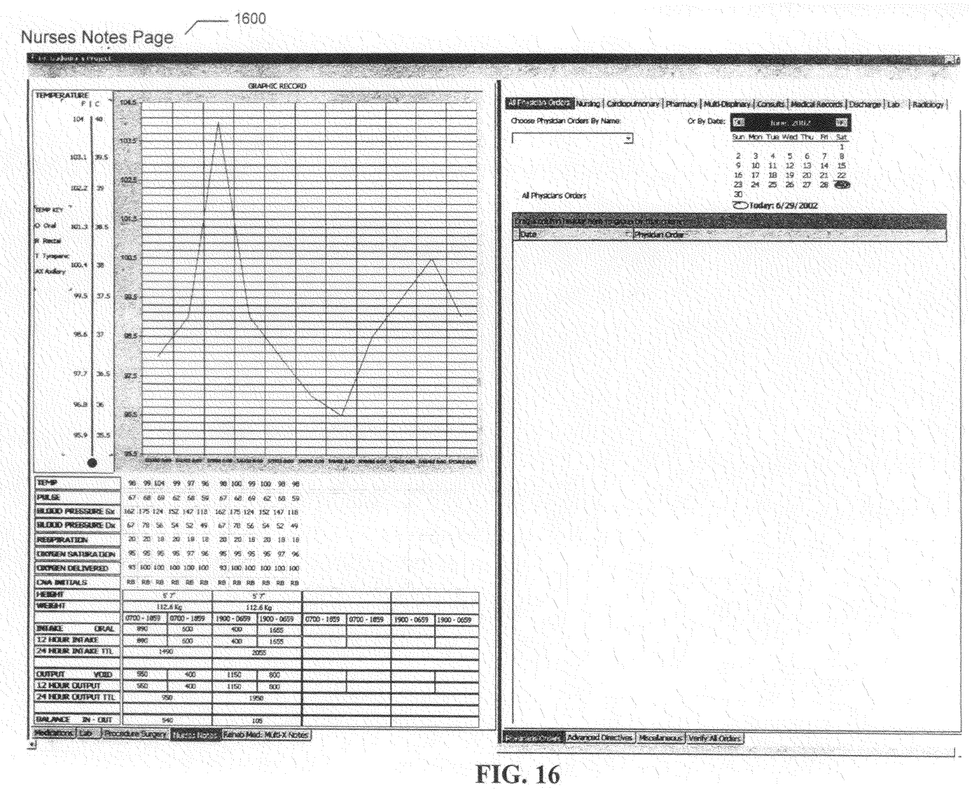

FIG. 16 illustrates a nurses notes page according to the present invention. The Nurses Notes Page 1600 can be implemented as a pop-up display screen or window without departing from the scope of the present invention.

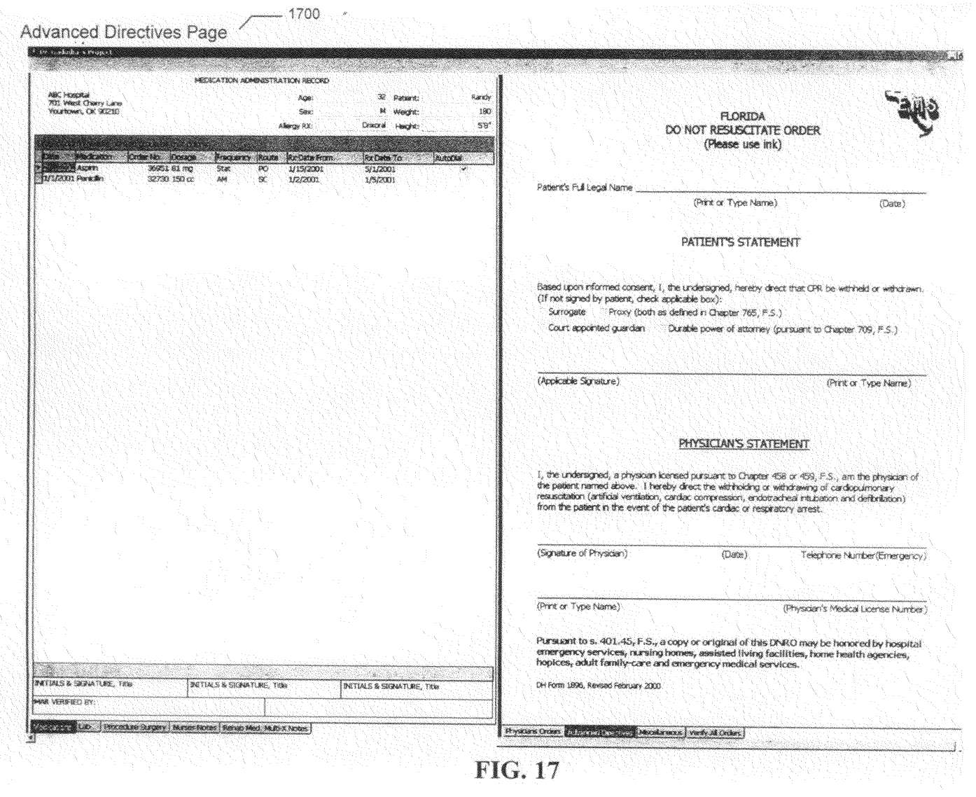

FIG. 17 illustrates an advanced directives page according to the present invention. The Advanced Directives Page 1700 can be implemented as a pop-up display screen or window without departing from the scope of the present invention.

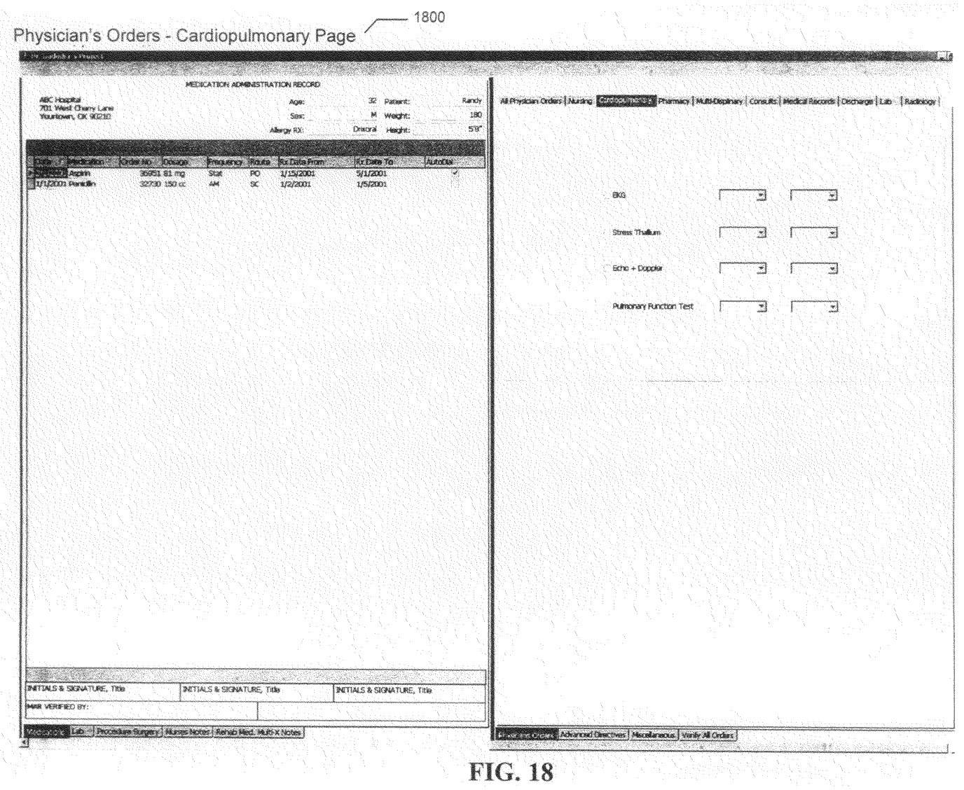

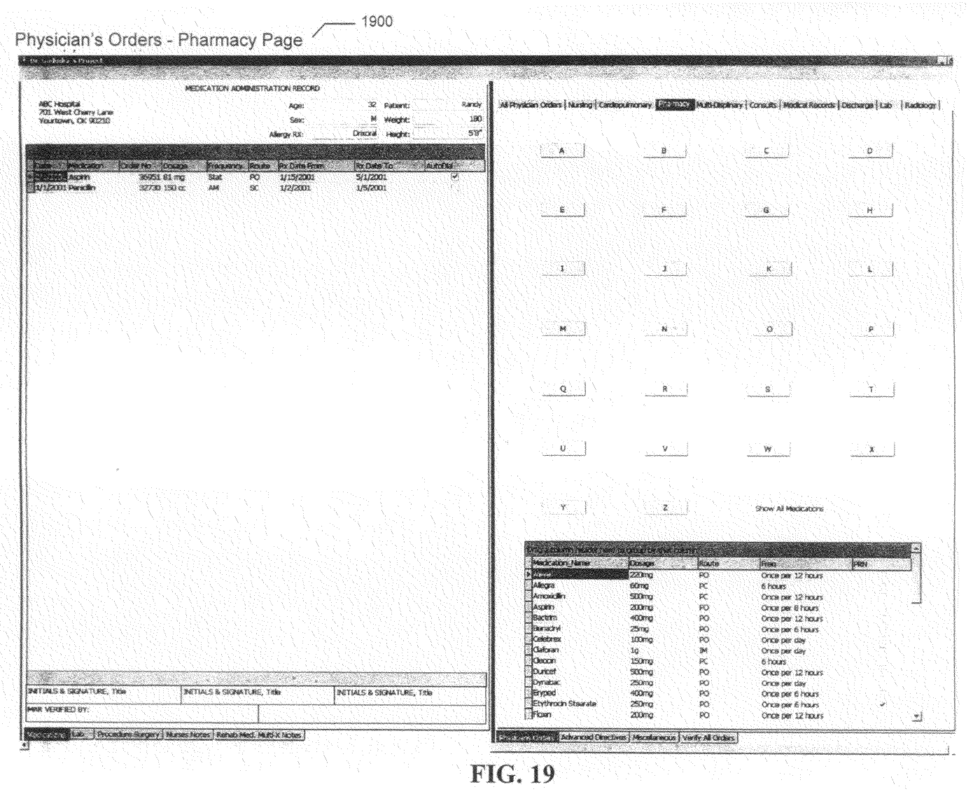

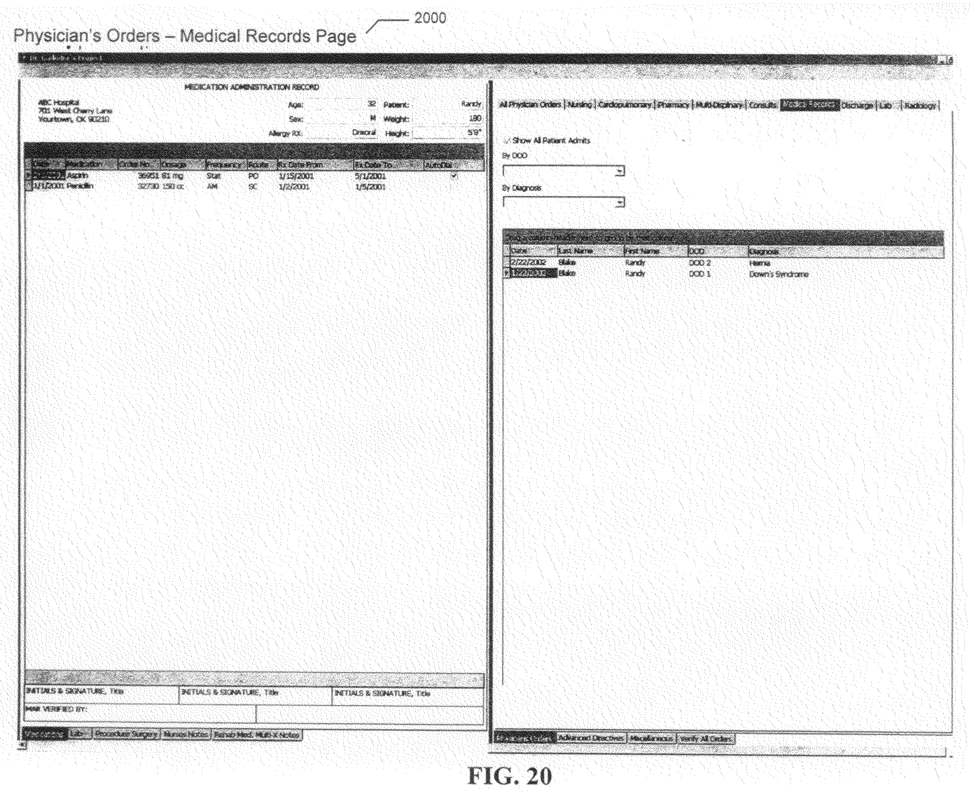

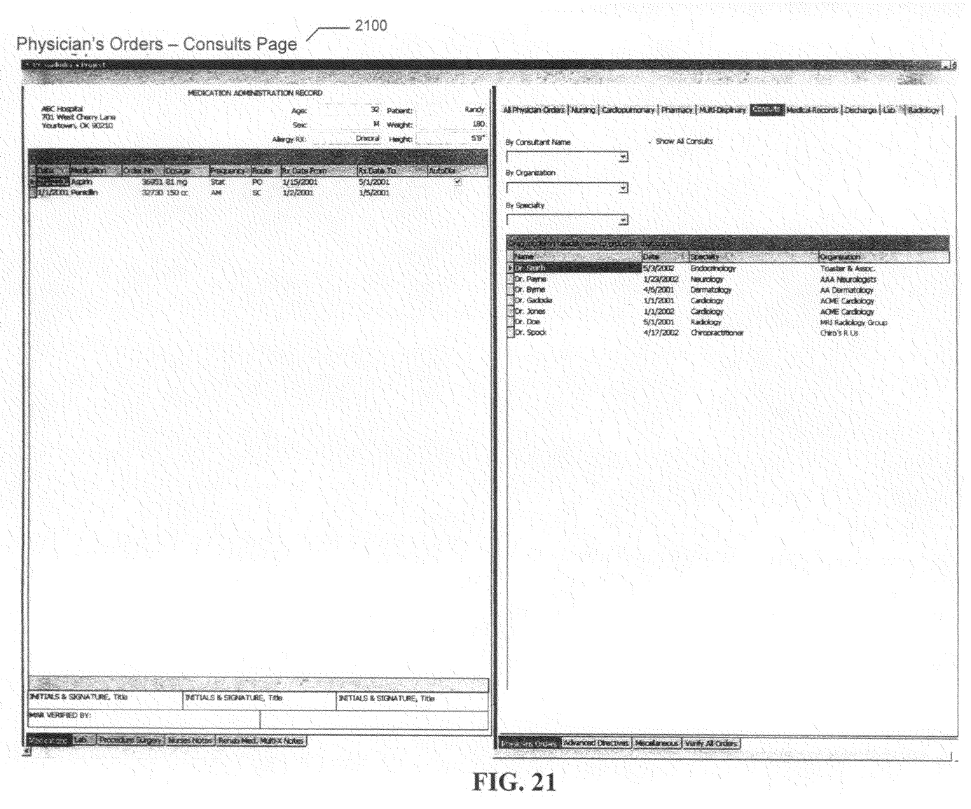

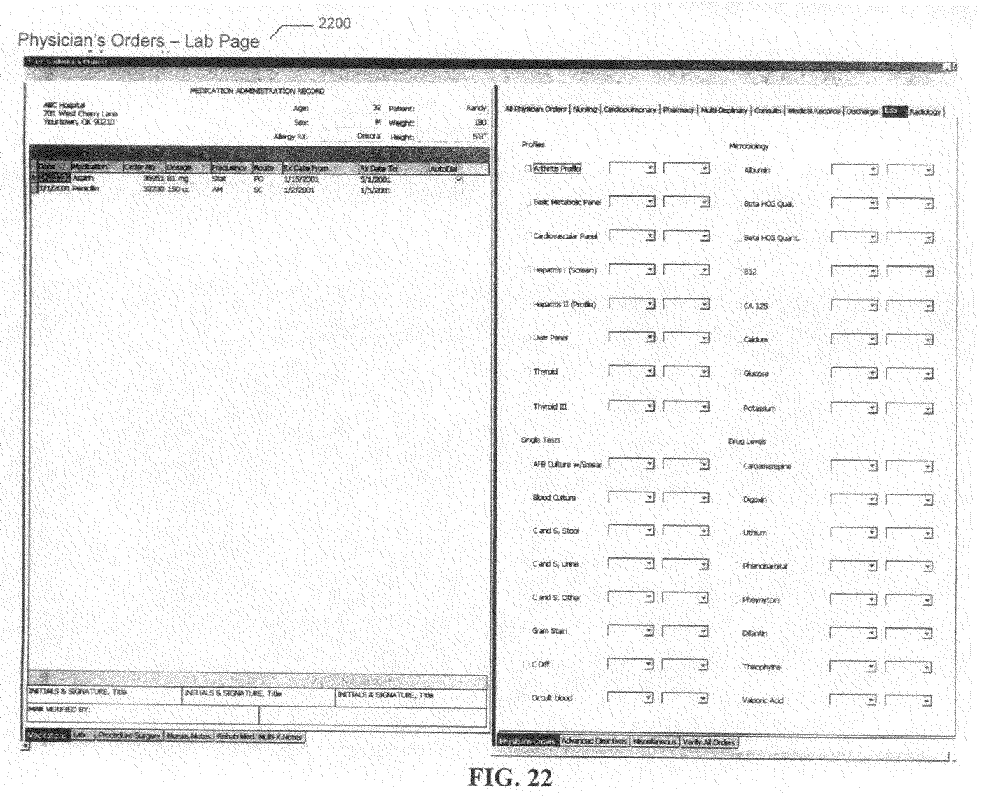

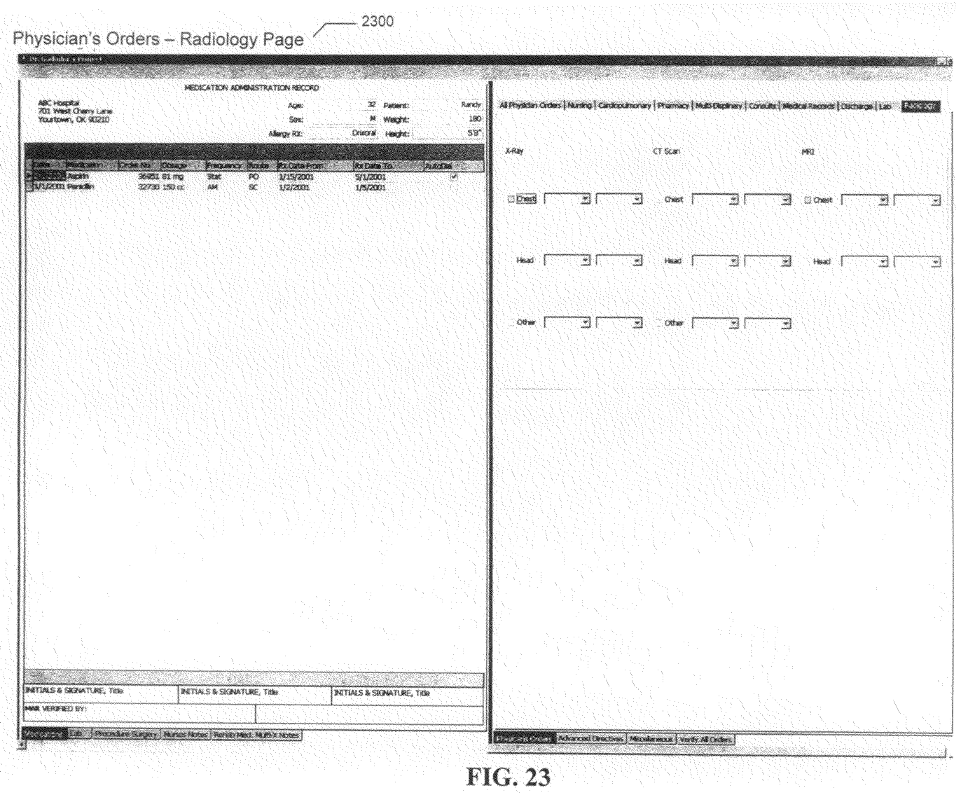

FIGS. 18, 19, 20, 21, 22, and 23 illustrate physician's orders pages according to the present invention. The Physician's Orders Pages 1800, 1900, 2000, 2100. 2200, and 2300 can be implemented as pop-up display screens or windows without departing from the scope of the present invention.

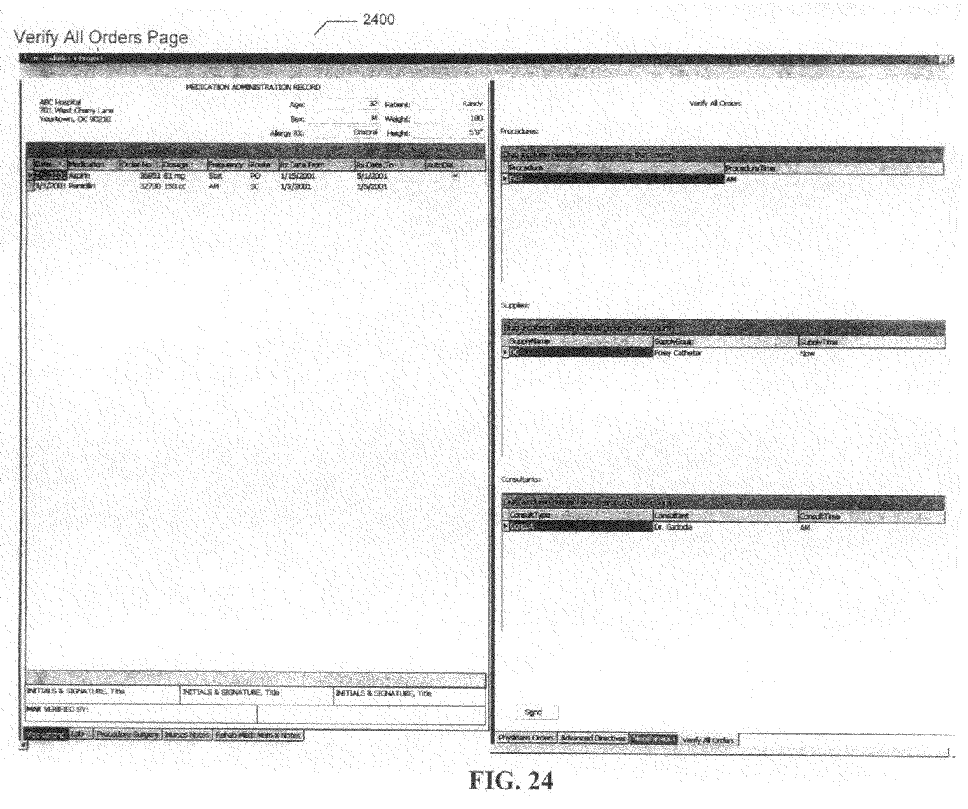

FIG. 24 illustrates a verify all orders page according to the present invention. The Verify All Orders Page 2400 can be implemented as a pop-up display screen or window without departing from the scope of the present invention.

By utilizing the workflow oriented healthcare information management system of the present invention, then, the physician can write orders while viewing labs and medications. An X-ray report and problem list will be visible at the same time while the physician is writing SOAP notes. In addition, DRGs can be applied at the same time the physician is writing orders and progress notes. Erroneous medication orders will not occur since the dosage and route will be verified. Furthermore, writing discharge orders is simplified since all prescribed medications can be automatically printed. This will reduce processing time and improve physician efficiency while reducing errors. To further streamline the healthcare workflow, automatic fingerprinting and electronic signature can be utilized to facilitate signing of all records. As the result, physicians will benefit from improved efficiency, less time spent on charting, and more time spent with the patients. Errors will be reduced significantly throughout the entire healthcare process or workflow.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A workflow oriented multi-screen healthcare information management system comprising:
a first screen for managing information in a healthcare workflow, the first screen comprising two or more screen areas for providing healthcare information display and manipulation functions for a first point in the healthcare workflow;
a second screen for managing information in the healthcare workflow, the second screen comprising two or more screen areas for providing healthcare information display and manipulation functions for a second point in the healthcare workflow;
an interface to one or more healthcare information systems; and
an information integration module to integrate information on the one or more healthcare information systems with the first screen and the second screen for managing information in the healthcare workflow such that the information on the one or more healthcare information systems are managed from the first screen and the second screen,
wherein the first screen and the second screen has a logical relation in the healthcare workflow, and wherein a user can switch between the first screen and the second screen without exiting either screen.

2. The system of claim 1, wherein the first screen comprises two or more screen areas for providing healthcare information display and manipulation functions for patient demographics, and the second screen comprises two or more screen areas for providing information display and manipulation functions for healthcare diagnosis in the healthcare workflow.

3. The system of claim 1, wherein the first screen comprises two or more screen areas for providing healthcare information display and manipulation functions for patient demographics, and the second screen comprises two or more screen areas for providing information display and manipulation functions for healthcare financials in the healthcare workflow.

4. The system of claim 1, wherein the first screen comprises two or more screen areas for providing healthcare information display and manipulation functions for healthcare diagnosis in the healthcare workflow, and the second screen comprises two or more screen areas for providing healthcare information display and manipulation functions for post-diagnosis actions in the healthcare workflow.

5. The system of claim 4, wherein the post-diagnosis actions in the healthcare workflow include automated healthcare order processing.

6. The system of claim 4, wherein the for post-diagnosis actions in the healthcare workflow include automated prescription processing.

7. The system of claim 1, wherein the first screen comprises two or more screen areas for providing healthcare information display and manipulation functions for patient discharge in the healthcare workflow, and the second screen comprises two or more screen areas for providing healthcare information display and manipulation functions for post-discharge actions in the healthcare workflow.

8. The system of claim 7, wherein the for post-discharge actions in the healthcare workflow include automated healthcare order processing.

9. The system of claim 7, wherein the for post-discharge actions in the healthcare workflow include automated prescription processing.

10. The system of claim 1, wherein the first screen provides a first portion of the patient history for a patient and the second screen provides a second portion of the patient history such that the first and second screens provide a complete patient history for the patient.

11. A method for workflow oriented multi-screen healthcare information management, the method comprising:
displaying a first screen for managing information for a first point in a healthcare workflow;
displaying within the first screen two or more screen areas for providing healthcare information display and manipulation functions;
providing within the two or more screen areas of the first screen healthcare information display and manipulation functions for the first point in a healthcare workflow;
displaying a second screen for managing information for a second point in a healthcare workflow;
displaying within the second screen two or more screen areas for providing healthcare information display and manipulation functions;
providing within the two or more screen areas of the second screen healthcare information display and manipulation functions for the second point in a healthcare workflow;
providing an interface to one or more healthcare information systems; and
integrating information on the one or more healthcare information systems with the first screen and the second screen for managing information in the healthcare workflow such that the information on the one or more healthcare information systems are managed from the first screen and the second screen,
wherein the first screen and the second screen has a logical relation in the healthcare workflow, and wherein a user can switch between the first screen and the second screen without exiting either screen.

12. The method of claim 11, wherein the first screen comprises two or more screen areas for providing healthcare information display and manipulation functions for patient demographics, and the second screen comprises two or more screen areas for providing information display and manipulation functions for healthcare diagnosis in the healthcare workflow.

13. The method of claim 11, wherein the first screen comprises two or more screen areas for providing healthcare information display and manipulation functions for patient demographics, and the second screen comprises two or more screen areas for providing information display and manipulation functions for healthcare financials in the healthcare workflow.

14. The method of claim 11, wherein the first screen comprises two or more screen areas for providing healthcare information display and manipulation functions for healthcare diagnosis in the healthcare workflow, and the second screen comprises two or more screen areas for providing healthcare information display and manipulation functions for post-diagnosis actions in the healthcare workflow.

15. The method of claim 14, wherein the post-diagnosis actions in the healthcare workflow include automated healthcare order processing.

16. The method of claim 14, wherein the for post-diagnosis actions in the healthcare workflow include automated prescription processing.

17. The method of claim 11, wherein the first screen comprises two or more screen areas for providing healthcare information display and manipulation functions for patient discharge in the healthcare workflow, and the second screen comprises two or more screen areas for providing healthcare information display and manipulation functions for post-discharge actions in the healthcare workflow.

18. The method of claim 17, wherein the for post-discharge actions in the healthcare workflow include automated healthcare order processing.

19. The method of claim 17, wherein the for post-discharge actions in the healthcare workflow include automated prescription processing.

20. The method of claim 11, wherein the first screen provides a first portion of the patient history for a patient and the second screen provides a second portion of the patient history such that the first and second screens provide a complete patient history for the patient.

21. A system for workflow oriented multi-screen healthcare information management, the system comprising:
means for displaying a first screen for managing information for a first point in a healthcare workflow;
means for displaying within the first screen two or more screen areas for providing healthcare information display and manipulation functions;
means for providing within the two or more screen areas of the first screen healthcare information display and manipulation functions for the first point in a healthcare workflow;
means for displaying a second screen for managing information for a second point in a healthcare workflow;
means for displaying within the second screen two or more screen areas for providing healthcare information display and manipulation functions;
means for providing within the two or more screen areas of the second screen healthcare information display and manipulation functions for the second point in a healthcare workflow;
means for providing an interface to one or more healthcare information systems; and
means for integrating information on the one or more healthcare information systems with the first screen and the second screen for managing information in the healthcare workflow such that the information on the one or more healthcare information systems are managed from the first screen and the second screen,
wherein the first screen and the second screen has a logical relation in the healthcare workflow, and wherein a user can switch between the first screen and the second screen without exiting either screen.

22. Computer-executable process steps for workflow oriented multi-screen healthcare information management, the steps comprising:
a step for displaying a first screen for managing information for a first point in a healthcare workflow;
a step for displaying within the first screen two or more screen areas for providing healthcare information display and manipulation functions;
a step for providing within the two or more screen areas of the first screen healthcare information display and manipulation functions for the first point in a healthcare workflow;
a step for displaying a second screen for managing information for a second point in a healthcare workflow;
a step for displaying within the second screen two or more screen areas for providing healthcare information display and manipulation functions;
a step for providing within the two or more screen areas of the second screen healthcare information display and manipulation functions for the second point in a healthcare workflow;
a step for providing an interface to one or more healthcare information systems; and
a step for integrating information on the one or more healthcare information systems with the first screen and the second screen for managing information in the healthcare workflow such that the information on the one or more healthcare information systems are managed from the first screen and the second screen,
wherein the first screen and the second screen has a logical relation in the healthcare workflow, and wherein a user can switch between the first screen and the second screen without exiting either screen.
